(19) United States
(12) Patent Application Publication
(10) Pub. No.: US 2005/0207444 A1
(43) Pub. Date: Sep. 22, 2005

(54) Hybrid network element for a multi-protocol layered transmissions network and a graphical representation of the network

(75) Inventors: Yakov Zimmerman, Elkana (IL); Einat Gabso, Bat Yam (IL); Merav Cohen, Bet-Arie (IL); Natalia Malamud, Kfar Sava (IL)

Correspondence Address: Harold L. Novick;NATH & ASSOCIATES PLLC, 1030 15th Street, N.W. - 6th Floor, Washington, DC, 20005, US

(73) Assignee: ECI TELECOM LTD.

(21) Appl. No.: 11/099,673

(22) Filed: Apr. 6, 2005

Related U.S. Application Data
(63) Continuation-in-part of application No. 09/758,354, filed on Jan. 12, 2001, now abandoned.

(30) Foreign Application Priority Data
Jan. 14, 2001 (IL) 134047

(51) Int. Cl. H04J 3/16

(52) U.S. Cl. 370/469

(57) ABSTRACT

For use in a multi-protocol layered transmissions network including a plurality of network elements, a hybrid network element capable of operating at more than two layers, and a method for displaying a model of the multi-protocol layered transmissions network. The method comprises the steps of: determining different and preferably hierarchically related protocol layers in the multi-protocol layered transmissions network; and for each protocol layer, displaying an overlay including the hybrid network elements if operative in the protocol layer, displaying at least one physical link and/or a logical link interconnecting pairs network elements, wherein displaying a logical link so as to show that transport service along the logical link is at least partially provided by a transmission path on a protocol layer underlying the protocol layer. The method preferably comprises displaying a pair of association links between each logical link and its associated transmission path.

The present application is a CIP patent application of the U.S. Ser. No. 09/758,354 filed Jan. 12, 2001 and claiming priority of Jan. 14, 2000.

### FIELD OF THE INVENTION

The present invention is in the field of digital telecommunication systems in general, and Network Management System (NMS) applications, in particular.

### BACKGROUND OF THE INVENTION

Modern digital telecommunication systems employ single protocol network elements and/or hybrid protocol network elements to form multi-protocol layered transmissions networks. Two network elements can be interconnected over a physical link, or over a logical link where the actual transmission path is on an underlying protocol layer effectively acting as a server protocol layer in a client/server relationship to a client protocol layer requiring a transport service. Each protocol layer is conventionally managed by a protocol layer specific Network Management System (NMS) application, thereby negating client/server relationships between pairs of protocol layers to the detriment of the management of a multi-protocol layered transmissions network.

U.S. Pat. No. 5,953,347 to Wong describes integrated management of multiple networks with different topology domains, by employing hierarchical pass-through routing and multi-network service management through such a network. Wong describes and illustrates that the whole network may operate according to one or an other protocol, while the different domains of the same network always belong to one and the same protocol of that network. In other words, Wong does not describe that different domains of the network may operate according to respective different protocols and, consequently, does not propose any means for displaying operation of such a network. It should also be mentioned that network elements utilized in the network described by Wong are regular network elements and each of them is operative only in the network domain to which it belongs.

### SUMMARY OF THE INVENTION

In accordance with a first aspect of the present invention, there is provided a hybrid network element for use in a multi-protocol layered transmissions network, wherein each of the layers is associated with at least one communication protocol different from the communication protocols associated with the remaining layers, said hybrid network element is adapted to operate in any one of three or more layers of the layered network, and comprising a traffic processing means adapted to process incoming traffic, conveyed in accordance with a first communication protocol associated with a first of said layers, into outgoing traffic to be conveyed in accordance with a second communication protocol associated with at least one of the remaining two or more layers, thereby enabling traffic received at a port associated with said first layer to be forwarded to another one of said layers, being an adjacent or a non-adjacent layer to said first layer, through a port associated with said another layer after having the traffic processed into a traffic format that is in accordance with a communication protocol associated with said another layer.

The processing means of the hybrid network element is capable of performing at least one operation selected from the following non-exhaustive list comprising: aggregation, prioritization, scheduling, fragmentation, compression, protocol conversion. Preferably, the processing means is capable of performing protocol conversion and at least one additional operation selected from the above list.

A layer in the multi-protocol network may be associated with a number of communication protocols differing from one another by one or more parameters, for example by bit rate. Similarly, different layers may be associated with respective communication protocols altering from one another by bit rate or the like.

Preferably, the hybrid network element is adapted for use in the layered network comprising a group of layers respectively associated with different communication protocols hierarchically related to one another.

Further preferably, the different communication protocols hierarchically related to one another are IP, SDH/SONET and WDM, and said group of layers comprises three layers where two outer layers are adjacent to one intermediate layer.

The above-mentioned hybrid network element preferably comprises two or more functional units (for example, hardware/software cards or modules) interconnected via the internal traffic processing means of said hybrid network element, each of said functional units being provided with input/output ports or an internal communication bus adapted to receive/issue traffic at least at two different communication protocols.

For use with a network element operative in a multi-protocol layered transmissions network, wherein said network element is operative in any one of three or more layers of said network, there is also proposed a method for forwarding traffic received along one of said layers towards another layer, which method comprises the steps of:
receiving incoming traffic conveyed along one of said layers, wherein said incoming traffic is conveyed in accordance with a first communication protocol associated with said one layer;
processing said received traffic into traffic adapted to be conveyed in accordance with a second communication protocol, wherein said second communication protocol is associated with at least one of the remaining two or more layers,
forwarding said processed traffic towards another layer being an adjacent or a non-adjacent layer to said first layer, wherein said another layer is associated with said second communication protocol.

In accordance with a further aspect of the present invention, there is provided method for displaying traffic topology of a multi-protocol layered transmissions network, for use in a multi-protocol Network Management System application for managing said transmissions network including a plurality of network elements, the method comprising the steps of:
i. determining the layers in the multi-layered transmissions network, such that each of the layers is associated with at least one communication (network) protocol different from the communication (network) protocols associated with the remaining layers;
ii. for each layer, displaying an overlay including the network elements operative in the layer (or functional units of the network elements, being relevant to the layer and thus operative in the layer), and displaying at least one physical link and/or at least one logical link interconnecting pairs of network elements or functional units thereof, wherein said at least one logical link being displayed if transport service along a said logical link is at least partially provided by a transmission path on a layer underlying said layer.
   Optionally and preferably, the method comprises a further step
iii. displaying a pair of association links between each of said logical links and its associated transmission path.

Different layers of said network including one layer underlying another layer, may be respectively associated with different hierarchically related communication protocols.

The transmission path may comprise a number of physical links and/or a number of logical links in the mentioned underlying protocol layer.

Preferably, the method comprises displaying a particular logical link in a particular layer, using a graphical manner being indicative of one or more layers where a transmission path corresponding to said particular logical link is located, the method further comprising displaying physical links belonging to different layers as visually distinctive from one another.

Further preferably, the method comprises displaying, at the particular layer, more than one said logical links in the form of respective more than one graphically different lines connecting a pair of the network elements, thereby allowing to distinguish how many and which underlying layers provide transport service for traffic between said network elements at a particular layer.

The above method can be utilized for generating and displaying a model of the multi-protocol layered network comprising hybrid elements.

To this end, the method may further comprise wherein said plurality of network elements comprises at least two hybrid network elements each being operative in more than one layer, and wherein:
step (ii) of displaying the overlay of each of said layers, further comprises displaying any of said at least two hybrid network elements or a functional unit thereof that is currently operative at said layer.

Preferably, at the step of displaying said at least one logical link in the overlay, the method comprises representing said logical link as a line interconnecting said hybrid network elements or functional units thereof and being graphically indicative of the underlying layer including said transmission path (for example, according to any preliminarily assigned scheme of indications).

In one specific embodiment, at least one particular element of said at least two hybrid elements can be operative in more than two layers.

In such a case (though not only in that case), the method may further comprise displaying at least one direct association link between one particular of said hybrid network elements (or a first functional unit thereof) included at said layer and between an additional transmission path at a layer non-directly underlying said layer (i.e., non adjacent layer), wherein said additional transmission path being associated with said particular hybrid network element (or a second functional unit thereof).

The multi-protocol Network Management System (NMS) application implementing the method of the present invention is preferably capable of automatically determining and displaying the physical links and the logical links in each protocol layer, and the subsequent association and displaying of each logical link to the corresponding transmission path providing the actual transport service thereto. Additionally, the envisaged multi-protocol NMS application preferably supports operator intervention in the client/server graphical model of the network to provide greater flexibility, for example, for enabling the establishment of links with a network element whose adaptation functionality from one technology to another is not directly under the control of the NMS application, enabling the use of the client/server graphical model for modeling purposes, and the like. By virtue of the present invention, it is envisaged that a multi-protocol NMS application may facilitate management of multi-protocol layered transmissions networks including inter alia a richer content wise representation of a transmissions network on a Graphical User Interface (GUI), as well as alarm management, event propagation, protected path provisioning, and the like.

The proposed inventive hybrid network element enables effective operation of multi-protocol layered transmission network and allows clear graphical representation of such a network and its traffic topology.

### BRIEF DESCRIPTION OF THE DRAWINGS

In order to understand the invention and to see how it can be carried out in practice, a preferred embodiment will now be described, by way of a non-limiting example only, with reference to the accompanying drawings, in which similar parts are likewise numbered, and in which:

FIG. 1 is a schematic representation showing the network traffic topology of a multi-protocol layered transmissions network;

FIG. 2 is a flow diagram showing the steps of generating and displaying a client/server model of a multi-protocol layered transmissions network, as carried out by a multi-protocol Network Management System (NMS) application of the present invention;

FIG. 3 is a schematic representation showing the client/server hierarchy of the IP/SDH/DWM protocol layers of the transmissions network of FIG. 1;

FIG. 4 is a schematic 3D graphical representation of the client/server model of the transmissions network of FIG. 1;

FIG. 5A is a schematic graphical representation of the top view of the overlay of the IP protocol layer of the client/server model of FIG. 4;

FIG. 5B is a schematic graphical representation of the overlay of the IP protocol layer of the transmissions network of FIG. 1 as generated by a conventional IP NMS application;

FIG. 6A is a schematic graphical representation of the top view of the overlay of the SDH/SONET protocol layer of the model of FIG. 4;

FIG. 6B is a schematic graphical representation of the overlay of the SDH/SONET protocol layer of the transmissions network of FIG. 1 as generated and displayed by a conventional SDH/SONET NMS application;

FIG. 7 is a schematic graphical representation of the overlay of the WDM protocol layer of the client/server model of FIG. 4; and

FIG. 8 is a flow diagram showing the steps of applying the model of the present invention in alarm analysis.

### DETAILED DESCRIPTION OF THE DRAWINGS

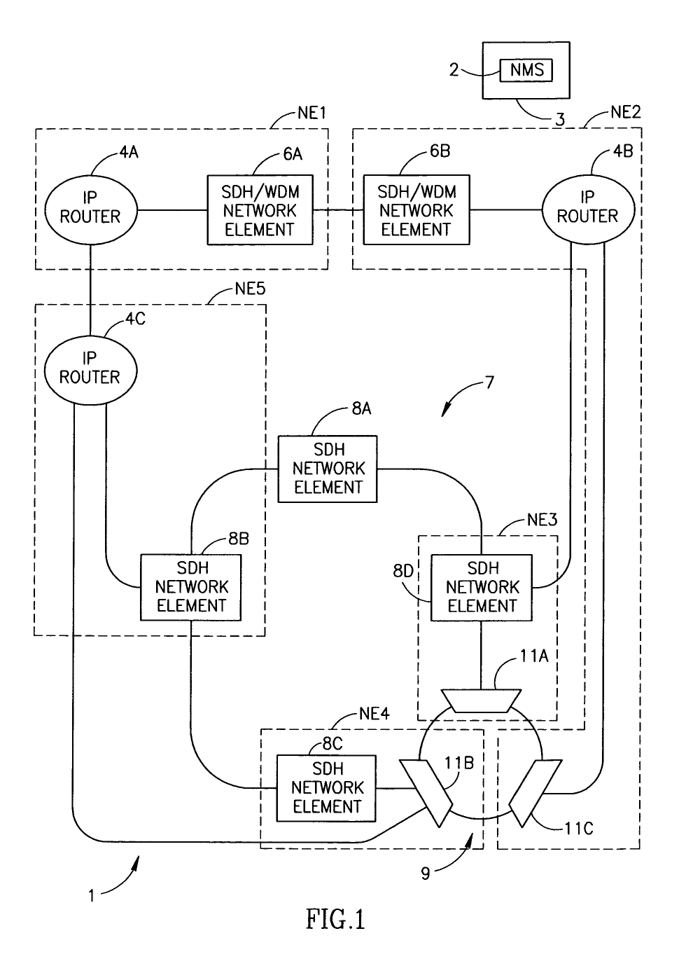

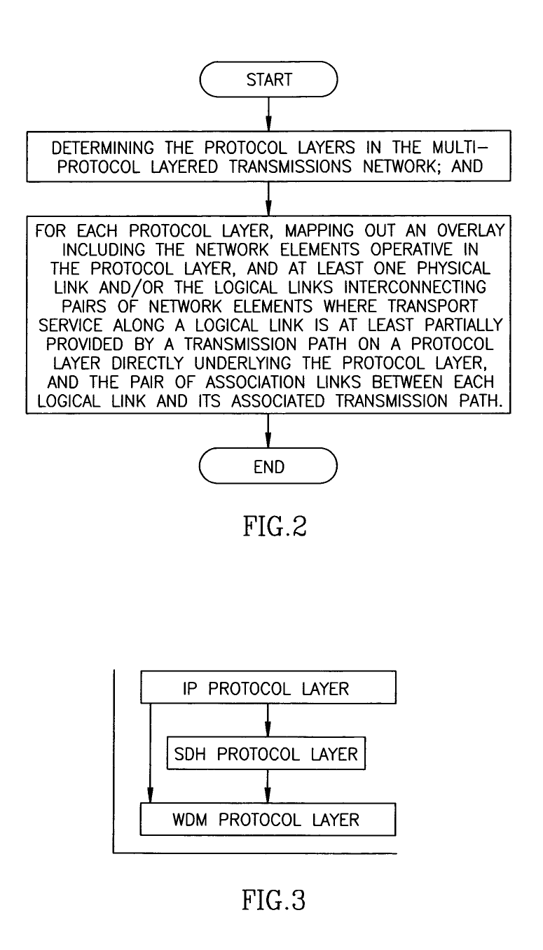

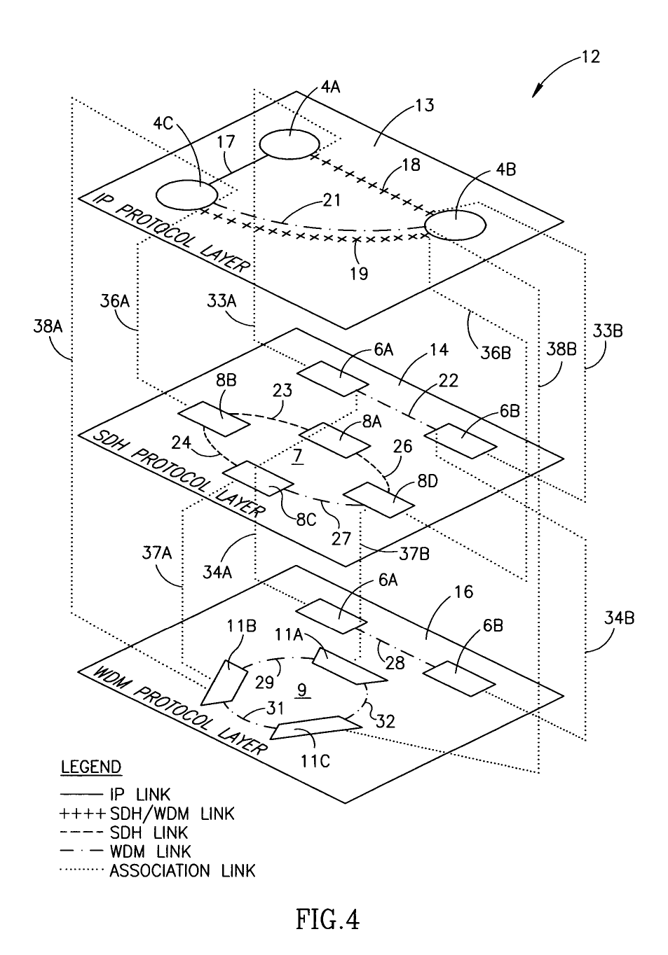

FIG. 1 shows a multi-protocol layered transmissions network 1 managed by a multi-protocol Network Management System (NMS) application 2 running on a computer 3. The transmissions network 1 includes network elements (comprised of functional units) operative on one or more of three protocol layers, namely, IP, SDH/SONET and WDM, and in which the WDM protocol layer acts as a server protocol layer to both IP and SDH client protocol layers, and the SDH protocol layer acts as a server protocol layer to the IP client protocol layer (see FIG. 3). The network elements include the following functional units for the purpose of the present description:
three IP routers 4A, 4B and 4C belonging to an upper, IP-protocol layer of the network and further illustrated in this upper protocol layer,
a pair of integrated SDH/WDM network elements 6A and 6B, performing just simple protocol conversion (In FIG. 4, shown both in the SDH and in the WDM protocol layers),
SDH network elements 8A, 8B, 8C, and 8D forming an SDH ring 7, and
WDM network elements 11A, 11B, and 11C forming a WDM ring 9.

The following composite hybrid network elements, that will be indicated as NE1-NE5 in the present description, are implemented from the functional units listed above:

NE1=4A, 6A (operative in three layers)
NE2=6B, 4B, 11C (operative in three layers)
NE3=8D, 11A (operative in two layers)
NE4=8C, 11B (operative in two layers)
NE5=4C, 8B (operative in two layers)

It should be noted that in practice, the hybrid NE according to the invention comprises integrated different functional units (in the form of cards, modules) interconnected via traffic processing means (not shown) and thereby enabling operation of the NE at different protocol layers.

In one specific example, the IP traffic from any external router (not shown) enters in IP router 4A of the NE1 (in this example, to its IP port) where the traffic is processed, for example it is analyzed and classified. Classification of the traffic may be based on identification using CD-VLAN ids, 802.1p mapping or another mechanism known to those skilled in the art. The traffic is then encapsulated and framed using Generic Framing Protocol (GFP) or other techniques, placed in SDH/SONET containers, fragmented (by virtual concatenation including sequencing and LCAS protocols applied; LCAS being Link Capacity Adjustment Scheme) and then routed by the IP router to the appropriate port of the NE1 for transport. The port selected in this case may be an integrated SDH (SONET)/WDM port (marked as the element 6A operative both at the SDH/SONET layer and the WDM layer and comprising, for example, an SDH/SONET port with Forward Error Correction—FEC and WDM transmitter). The IP traffic that was mapped in the above way to fit into SDH/SONET frames will be transported using WDM.

It can be done, for example, as described below. The traffic can be received by a peer integrated SDH(SONET)/WDM port (illustrated as a peer functional unit 6B comprising an SDH port with FEC and WDM receiver and belonging to the NE2). The traffic from the peer port 6B is sent to the IP router (4B) of the NE2 for processing. The router 4B will then dynamically choose, using scheduling and shaping functions of the IP router portion of the NE2, where to route the data. IP SDH/SONET port existing at 8D (NE3) may be chosen as the destination—in which case the traffic will leave 4B as IP traffic and will enter the adjacent SDH/SONET layer via the integrated port of element 8D.

An alternative is for the IP router 4B to decide to transmit the data directly from a WDM port of the NE2 (which port exists in the functional unit 11C being for example an OADM card). In the latter case the traffic is routed internally in the NE2 to an optical interface (with a specific optical wavelength being used) and then multiplexed with other WDM traffic using the OADM card (11C) of the NE2, thereby entering the non-adjacent WDM layer. If the WDM traffic is transmitted clockwise in the ring 9, the traffic will then be received in the WDM aggregate port of 11B belonging to NE4. Depending on the wavelength chosen in the previous NE2, the signal in NE4 will be either processed, including demultiplexing, and transmitted as an SDH/SONET signal to element 8C, or processed to be transmitted as an IP signal (say, using an Ethernet transmitter port of the OADM card of element 11B). If the traffic is sent as IP, it will be directly received by the IP router (4C) and then transmitted using the regular IP routing protocol to an external router (not shown) connected to 4C.

FIG. 4 shows a 3D representation (model) 12 of the traffic topology in the transmissions network 1 as generated/displayed in accordance with the method of the present invention. The graphical model 12 includes three overlays 13, 14 and 16 for the IP, SDH and WDM layers of the transmissions network 1, respectively. Model 12 includes the physical links of each layer, its logical links, and the so-called association links for associating each logical link to the transmission path providing the transport service thereto with one exception being the most underlying layer, in this case the WDM protocol layer, which only includes physical links.

FIG. 4 also shows the Legend of the different representations of the different IP/SDH (SONET)/WDM technologies, the representation of so-called hybrid SDH (SONET)/WDM logical links which rely on transport services from both SDH(SONET) and DWM physical links, and association links. These representations are constant per technology or combination of technologies in the sense that the same representation is used for a particular type of link irrespective of the actual overlays being displayed. These representations may be employed when displaying, for example, overlays of protocol layers on a Graphic User Interface (GUI), thereby enabling visual discrimination therebetween. Alternatively, other approaches may be employed including inter alia color coding, different lines' thickness, and the like.

The computerized overlay 13 of the IP protocol layer includes four links as follows: A physical IP link 17 interconnecting the IP routers 4A and 4C. A logical SDH/DWM link 18 interconnecting the IP routers 4A and 4B, which reflects traffic at least partially performed via the SDH(SONET) layer 14. A logical SDH/DWM link 19 and a logical WDM link 21 interconnecting the IP routers 4B and 4C reflect traffic performed at the SDH(SONET) layer and WDM layer, respectively. The computerized overlay 14 of the SDH(SONET) protocol layer includes five links as follows: A logical WDM link 22 interconnecting the SDH/WDM integrated functional units 6A and 6B, that reflects traffic actually performed at the lower WDM layer. Three physical SDH/SONET links 23, 24 and 26 interconnecting the pairs of SDH/SONET network elements or functional units (8A, 8B), (8B, 8C), and (8A, 8D) and a logical WDM link 27 interconnecting the pair of SDH/SONET network elements or functional units (8C, 8D), also reflecting the WDM traffic at the underlying WDM layer. The computerized overlay 16 of the WDM protocol layer includes four links as follows: A physical WDM link 28 interconnecting the SDH(SONET)/WDM network elements (functional units) 6A and 6B. And, three physical WDM links 29, 31, and 32 in the WDM ring 9.

FIG. 4 also shows five pairs of association links symbolically illustrating internal means of the hybrid network elements N1-N5 for traffic processing (see the detailed description to FIG. 1). These internal traffic processing means per se are not shown. A pair of association links 33A and 33B associating the logical SDH (SONET)/WDM link 18 with the logical WDM link 22. A pair of association links 34A and 34B associating the logical WDM link 22 with the physical WDM link 28. A pair of association links 36A and 36B associating the logical SDH/WDM link 19 with at least a portion of the SDH ring 7. A pair of association links 37A and 37B associating the logical WDM link 27 with the WDM ring 9. All the association links mentioned up to now interconnect between adjacent layers. A pair of association links 38A and 38B associating the WDM logical link 21 with the WDM ring 9, interconnect non-adjacent layers.

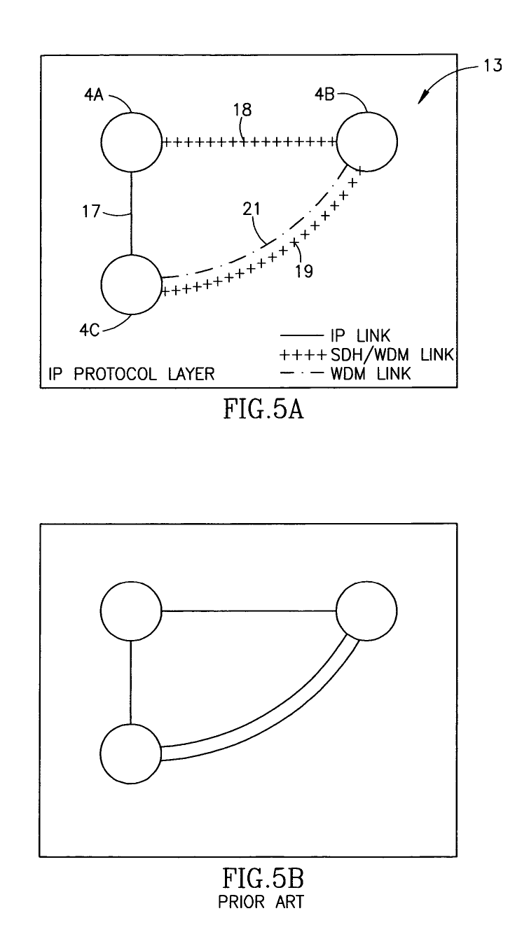

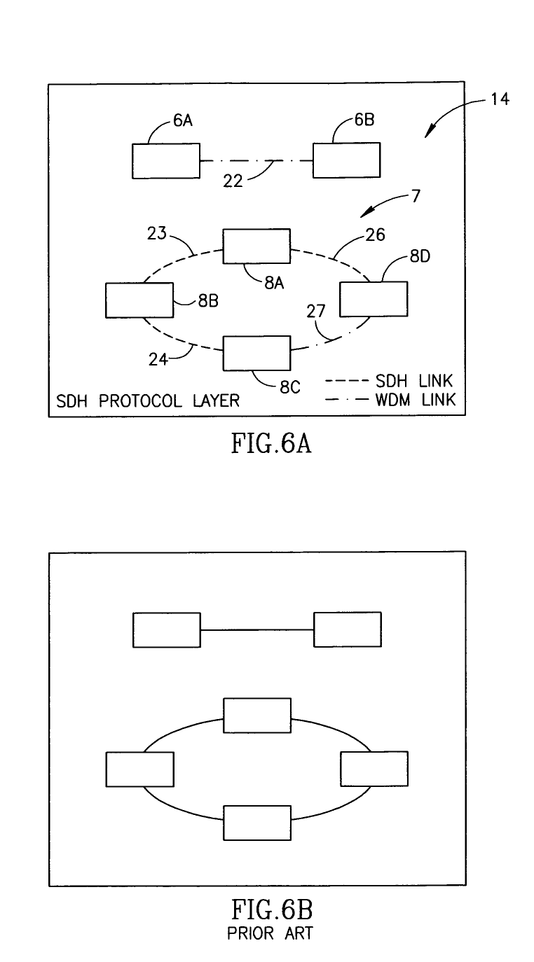

FIGS. 5A and 6A show that the overlays of the IP and SDH protocol layers 13 and 14 are richer content wise by virtue of the different technologies/combinations of technologies being displayed differently as opposed to their conventionally all being displayed identically as shown in FIGS. 5B and 6B.

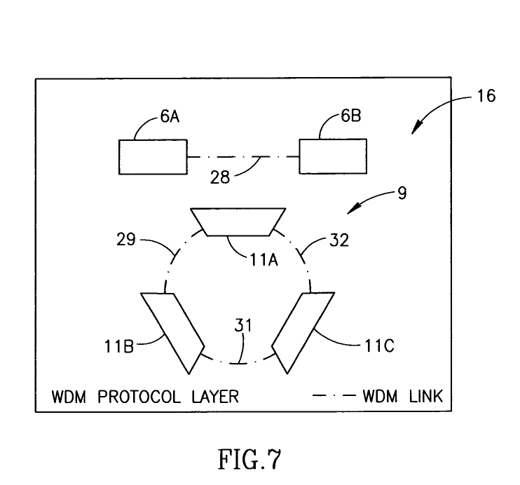

FIG. 7 illustrates the WDM protocol layer 16 wherein the three physical WDM links 29, 31 and 32 present part of WDM ring 9, as previously explained.

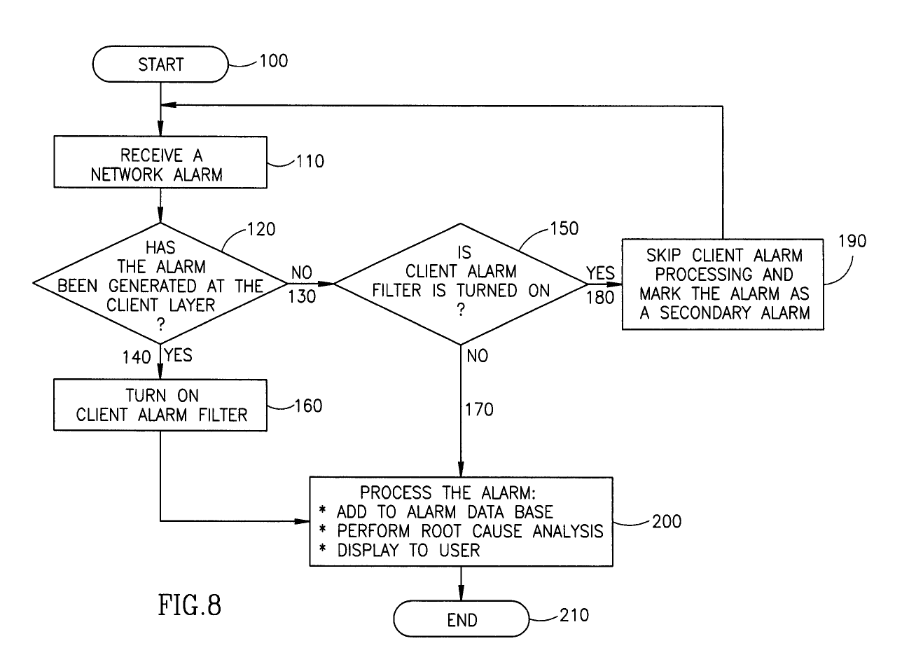

As will be appreciated by a person skilled in the art, construction of a model as disclosed by the present invention can be used for a variety of applications. A flow diagram of one such non-limiting example of an application is illustrated in FIG. 8. As will also be appreciated by a man skilled in the art other applications such as impact analysis (e.g. evaluating the impact of a future operation at one or more layers, such as maintenance operation, on the operation at the client layer), circuit provisioning based on any desired parameter (e.g. distance, delay, degradation in the signal quality, protection requirements and the like) can be carried out by using such a graphical model as provided by the present invention.

FIG. 8 presents a flow diagram showing the steps of an embodiment by which a graphical model as disclosed by the present invention is used in alarm analysis application. One of the major problems associated with the management of networks of the prior art is, that once an alarm is generated, the operator is not able to identify in which layer of the multi-layered network lies the problem. In other words, if the cause for the alarm is at the client layer or in any of the other underlying layers. The major importance of this embodiment is to allow to remove (automatically or by an operator) all alarms that are generated at the upper (client) layer and to focus on those generated only at the server layer. If for example, one of the physical WDM links becomes inoperative, this event can be propagated onto the logical WDM link of the computerized overlay of the SDH protocol layer (where this WDM logical link is suitably displayed so that can be distinguished from other logical links), and, in turn, onto the suitably displayed logical WDM link on the computerized overlay of the IP protocol layer. Therefore, once an alarm is received (110), it is visually determined whether the alarm is associated with the client layer or with any of the underlying layers (120). If the answer is no (130), it is determined whether the client alarm filter is turned on (150). The term “client alarm filter” is used herein to denote any means that is operative to eliminate different alarms that reach the client server and the primary cause for their generation is at a server layer associated with the client layer. If the answer to the latter step is affirmative (180) then there is no need to process a client alarm, the alarm may be marked as a non-client layer alarm (a secondary type of alarm) (190) and the process awaits the receipt of the next alarm.

If on the other hand, it is determined in step (120) that the alarm was generated at one of the underlying layers and not at the client layer (140), the client alarm filter is turned on and the alarm is removed from the list/database of client alarms (160). Following step (160), any one of the following steps may be taken or any combination thereof (200): processing the alarm, adding the alarm to the alarms database, performing root cause analysis of that current alarm and/or providing a display of the alarm. It is preferably based on visually distinctive representation of different logical and physical links on the overlays of the two or more protocol layers.

By another embodiment of the invention, a user can determine whether a path selected satisfies any parameter set or a combination of a number of parameters. For such application, the user set his criteria for the circuit required, the systems finds one possible path through the multiple layers available in accordance with the path end points, and then it is determined whether the path to be provisioned fulfills the criteria set. Preferably, it is determined whether the criteria are met at the client layer and recursively the path is determined for all underlying layers while retaining these criteria. Such selection criteria are preferably selected from the group comprising: distance of transmission, delay allowed in receiving the transmission, degradation of the transmitted signals, protection constrains, and the like or any combination thereof. As will be appreciated by those skilled in the art, in addition or alternatively, the criteria may be used as part of an algorithm for choosing a preferred transmission path while taking into consideration the server layer characteristics.

While the invention has been described with respect to a limited number of embodiments, it will be appreciated that many variations, modifications, and other applications of the invention can be made within the scope of the appended claims.

1. A hybrid network element for use in a multi-protocol layered transmissions network, wherein each of the layers is associated with at least one communication protocol different from the communication protocols associated with the remaining layers, said hybrid network element is adapted to operate in any one of three or more layers of the layered network, and comprising processing means adapted to process incoming traffic, conveyed in accordance with a first communication protocol associated with a first of said layers, into outgoing traffic to be conveyed in accordance with a second communication protocol associated with at least one of the remaining two or more layers, thereby enabling traffic received at a port associated with said first layer to be forwarded to another one of said layers, being an adjacent or a non-adjacent layer to said first layer, through a port associated with said another layer after having the traffic processed into a traffic format that is in accordance with a communication protocol associated with said another layer.

2. The hybrid network element according to claim 1, wherein said processing means is adapted to perform protocol conversion and at least one additional operation selected from a non-exhaustive list comprising aggregation, prioritization, scheduling, fragmentation, compression.

3. The hybrid network element according to claim 1, comprising two or more functional units interconnected via said processing means, each of said functional units being provided with input/output ports or an internal communication bus, adapted to receive/issue traffic at least at two different communication protocols.

4. The hybrid network element according to claim 1, wherein said layered network comprises a group of layers respectively associated with different communication protocols hierarchically related to one another.

5. The hybrid network element according to claim 2, wherein said communication protocols hierarchically related to one another are IP, SDH/SONET and WDM, and said group of layers comprises three layers where two outer layers are adjacent to an intermediate layer.

6. For use with a network element operative in a multi-protocol layered transmissions network and wherein said network element is operative in any one of three or more layers of said network, a method for forwarding traffic received along one of said layers towards another layer, which method comprises the steps of:
receiving incoming traffic conveyed along one of said layers, wherein said incoming traffic is conveyed in accordance with a first communication protocol associated with said one layer;
processing said received traffic into traffic adapted to be conveyed in accordance with a second communication protocol, wherein said second communication protocol is associated with at least one of the remaining two or more layers,
forwarding said processed traffic towards another layer being an adjacent or a non-adjacent layer to said first layer, wherein said another layer is associated with said second communication protocol.

7. A method for displaying traffic topology of a multi-protocol layered transmissions network, for use in a multi-protocol Network Management System application for managing said transmissions network including a plurality of network elements, the method comprising the steps of:
iv. determining the layers in the multi-layered transmissions network, such that each of the layers is associated with at least one communication protocol different from the communication protocols associated with the remaining layers;
v. for each layer, displaying an overlay including the network elements or functional units thereof operative in the layer, and displaying at least one physical link and/or at least one logical link interconnecting pairs of network elements or functional units thereof, wherein said at least one logical link being displayed if transport service along a said logical link is at least partially provided by a transmission path on a layer underlying said layer.

8. The method according to claim 7, further comprising step
vi. displaying a pair of association links between each of said logical links and its associated transmission path.

9. The method according to claim 7, wherein said transmission path comprises at least one logical link and/or at least one physical link belonging to said underlying layer.

10. The method according to claim 7, further comprising displaying a particular logical link in a particular layer, using a graphical manner being indicative of one or more layers where a transmission path corresponding to said particular logical link is located, the method further comprising displaying physical links belonging to different layers as visually distinctive from one another.

11. The method according to claim 10, further comprising displaying, at the particular layer, more than one said logical links in the form of respective more than one graphically different lines connecting a pair of said network elements, thereby allowing to distinguish how many and which underlying layers provide transport service for traffic between said network elements at a particular layer.

12. A method according to claim 7, wherein said plurality of network elements comprises at least two hybrid network elements each being operative in more than one layer, and wherein:
the step of displaying the overlay of each of said layers, further comprises displaying any of said at least two hybrid network elements or a functional unit thereof that is currently operative at said layer.

13. The method according to claim 12, further comprising representing said logical link as a line interconnecting said hybrid network elements or functional units thereof and being graphically indicative of the underlying layer including said transmission path.

14. The method according to claim 12, further comprising displaying at least one direct association link associated with a hybrid network element or a functional unit thereof, and extending between a first layer associated with said hybrid network element or functional unit thereof and a second, non-directly underlying layer associated with said hybrid network element or another functional unit thereof.

15. The method according to claim 12, wherein at least one of said at least two hybrid network elements is operative in more than two layers.

16. The method according to claim 7 further comprising the step of displaying a top view of the overlays of two or more layers of the multi-protocol layered transmissions network or parts thereof, superimposed one on the other.

17. The method according to claim 7, further comprising the step of displaying a 3D representation of overlays of two or more layers of the multi-protocol layered transmissions network or parts thereof, including the pair of association links between each logical link and its associated transmission path.

18. The method according to claim 7, further comprising a step of distinguishing between alarms generated at a client layer and those generated at any of the underlying layers, based on visually distinctive representation of different logical and physical links on the overlays of said two or more layers.

19. The method according to claim 7, further comprising a step of selecting a path in the multi-protocol layered transmissions network by using at least one selection criterion for the path to be provisioned.

20. The method according to claim 19, wherein said at least one selection criterion is selected from the group comprising: distance of transmission, delay allowed in receiving the transmission, degradation of the transmitted signals, protection constrains, or any combination thereof.
